(19) United States
(12) Patent Application Publication
(10) Pub. No.: US 2004/0013912 A1
(43) Pub. Date: Jan. 22, 2004

(54) Method and device for determining an alcohol concentration in the electrolyte of fuel cells

(76) Inventor: Walter Preidel, Erlangen (DE)

Correspondence Address: LERNER AND GREENBERG, I.E, PATENT ATTORNEYS AND ATTORNEYS AT LAW, Post Office Box 2480, Hollywood, FL, 33022-2480, US

(21) Appl. No.: 10/105,900

(22) Filed: Mar. 25, 2002

Related U.S. Application Data
(63) Continuation of application No. PCT/DE00/03166, filed on Sep. 12, 2000.

(30) Foreign Application Priority Data
Sep. 24, 1999 (DE) 199 45 928.2

(51) Int. Cl. H01M 8/00; H01M 10/48

(52) U.S. Cl. 429/12; 429/90

(57) ABSTRACT

The method for determining the alcohol concentration in the alcohol/water mixture of fuel cells which are operated with this mixture, is particularly suited for direct methanol fuel cells. A part of the alcohol/water mixture is separated off and is transported against a predetermined pressure. The part of the mixture that has been separated off is heated until it boils, the boiling temperature is measured and, from this measurement, the mole fraction of the alcohol in the mixture is determined.

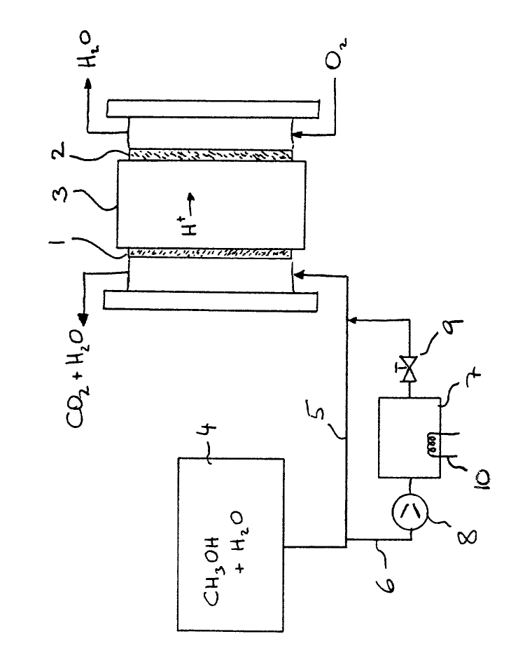

### CROSS-REFERENCE TO RELATED APPLICATION

This application is a continuation of copending International Application No. PCT/DE00/03166, filed Sep. 12, 2000, which designated the United States.

### BACKGROUND OF THE INVENTION

Field of the Invention

The invention relates to a method for determining the alcohol concentration in the alcohol/water mixture of fuel cells which are operated with this mixture, in particular direct methanol fuel cells (DMFCs). The invention also relates to an apparatus for carrying out the method.

To maintain the optimum operating parameters in fuel cells which are operated with liquid fuels, it is necessary to control the fuel concentration. For this purpose, the current concentration has to be determined.

Commonly assigned U.S. Pat. No. 5,624,538 (European patent application EP 0 684 469 A1) discloses a measuring unit for determining the concentration of low-molecular weight alcohols, such as methanol, in water or acids. That measuring unit has a porous anode for the electrochemical oxidation of alcohol, a cathode for the electrochemical reduction of oxygen, an ion-conducting membrane arranged between the anode and cathode and a diffusion-limiting membrane which is arranged on that side of the anode which is remote from the ion-conducting membrane. The measuring unit which, so to speak, represents a fuel cell is, for example, arranged in the fuel line and is held at a defined cell voltage by potentiostatic means. Depending on the alcohol concentration, a current flows through this fuel cell, and the concentration can be worked out—by means of a calibration curve—from the level of this current. A procedure of this nature is relatively complex, since current and voltage have to be measured or monitored.

In so-called direct methanol fuel cells (DMFCs), the fuel methanol undergoes direct electrochemical oxidation, that is, it is reacted without the intermediate step of a reforming operation (cf. in this respect, for example, M. Waidhas in K. Ledjeff (Ed.) “Brennstoffzellen: Entwicklung, Technologie, Anwendung” [Fuel Cells: Development, Technology, Applications], C. F. Müller Verlag GmbH, Heidelberg 1995, pages 137-156). To achieve the optimum operating point in a DMFC, it is necessary to operate with dilute fuel in excess. To avoid producing large amounts of waste, it is imperative, on account of operation being in excess, for the fuel to be circulated and the required concentration to be set by metering in concentrated fuel.

To return the alcohol/water mixture, i.e. for the anode cycle, an alcohol sensor is required, in order to match the metering of the alcohol into the cycle to the correspondingly optimum alcohol concentration for the current load. A number of requirements have to be satisfied when determining the alcohol level. For example, when the fuel cells are being used for electrical traction, the measurement method or the measurement cell, i.e. the sensor, has to be as inexpensive as possible. In the case of a stationary application, the requirement for prolonged maintenance-free operation is to the fore. In all cases, the temperature range of the sensor must include all possible operating temperatures of the fuel cells.

Commonly assigned, copending application Ser. No. 10/078,123 proposes a method for on-line determination of the fuel concentration in the electrolyte of fuel cells. The capacitance of a capacitor is measured with the fuel/electrolyte mixture, for example an alcohol/water mixture, as dielectric. From the measurement, there is determined the dielectric constant of the mixture and then the fuel concentration. The capacitance measurement, which is carried out continuously, generally takes place in the frequency range between 1 kHz and 1 MHz. The temperature dependency of the capacitance can be corrected using an additional temperature measurement. This measurement method per se satisfies the demands imposed on determination of alcohol, but the measurement is disrupted by gas bubbles. Since, by way of example, carbon dioxide, which forms as a result of the oxidation of the methanol, is dissolved in the anode liquid of direct methanol fuel cells, there are problems with determining the methanol concentration.

### SUMMARY OF THE INVENTION

It is accordingly an object of the invention to provide a method and a device for measuring the alcohol concentration in the fuel of a fuel cell, which overcomes the above-mentioned disadvantages of the heretofore-known devices and methods of this general type and which, while satisfying all the requirements imposed on a determination method of this type, is not impaired by gas or gas bubbles contained in the mixture.

With the foregoing and other objects in view there is provided, in accordance with the invention, a method of determining an alcohol concentration in an alcohol/water mixture of a fuel cell operated with the alcohol/water mixture, in particular of direct methanol fuel cells (DMFCs). The method comprises:

separating off a part of the alcohol/water mixture and transporting the part against a predetermined pressure;

heating the separated-off part of the alcohol/water mixture until boiling, and measuring a boiling temperature; and

determining, from the measured boiling temperature, a mole fraction of alcohol in the alcohol/water mixture.

There is also provided, in accordance with the invention, an apparatus for determining an alcohol concentration in an alcohol/water mixture of a fuel cell operated with the alcohol/water mixture and receiving the alcohol/water mixture through a delivery line, the apparatus comprising:

a branch line for branching off a part of the alcohol/water mixture;

a delivery pump arranged in the branch line;

a flow restriction in the branch line downstream of the delivery pump in a flow direction of the alcohol/water mixture;

a heating device disposed between the delivery pump and the flow restriction for heating the alcohol/water mixture, and a device for measuring a measuring a boiling temperature of the alcohol/water mixture.

According to the invention, this is achieved by the fact that a part of the alcohol/water mixture is separated off and is transported against a predetermined pressure, that the part of the mixture which has been separated off is heated until it boils, and that the boiling temperature is measured and, from this measurement, the mole fraction of the alcohol in the mixture is determined.

In this method, the fuel is an alcohol. The alcohol is in particular methanol, ethanol, propanol or glycol.

In the measurement method according to the invention, i.e. during the determination of alcohol, a small part of the liquid which is to be measured is separated off, for example 10 to 100 ml per hour is separated off. The part which has been separated off is then transported against an excess pressure and is heated, so that the liquid partially evaporates. In this method, it is essential for the heating power to be set in such a way that only part of the liquid evaporates, while the remaining part remains in liquid form. This is achieved as a result of the quantity of heat supplied per unit time being lower than the quantity of heat required for evaporation of the total amount of liquid transported through the heating section.

The heat required to heat the liquid to boiling point is negligible compared to the heat of evaporation. For example, the heat of evaporation of methanol is 35.4 kJ/mol, while that of water is 40.66 kJ/mol. At a pressure of 1013 hPa (760 Torr), the boiling point (boiling temperature) of methanol is 64.7° C., while that of water, by definition, is 100° C.

If a certain fixed excess pressure is then built up, the excess pressure advantageously being between 0.2 and 1·10⁵ Pa (i.e. between 0.2 and 1 bar), a specific boiling temperature is established depending on the mole fraction, i.e. the amount of substance, in the liquid. The boiling temperature is in this case fixed, provided that liquid and vapor are in thermodynamic equilibrium. The relationship between mole fraction and boiling temperature is known. For example, the boiling diagram for methanol/water mixtures is given in the Taschenbuch für Chemiker und Physiker [Handbook for Chemists and Physicists] by D'Ans-Lax (cf. 3rd edition, volume I, page 1-989).

The measurement method according to the invention advantageously has the highest resolution precisely in the range of low alcohol concentrations. For example, the boiling line at a pressure of 760 Torr (1013 hPa) results, for example, in a gradient of approx. 0.05° C. for 0.01 mol of methanol. This sensitivity is more than sufficient to determine the alcohol concentration in the electrolyte of fuel cells. The major advantage of the measurement method according to the invention is that dissolved gases or gas bubbles have no adverse effect on the boiling temperature of the mixture at constant pressure and therefore do not distort the measurement result. An apparatus for carrying out the method according to the invention has a line which branches off from the delivery line for the alcohol/water mixture, for part of the mixture. A delivery pump (for the mixture) is arranged in this line, and the delivery pump is followed by a pressure relief valve. In the line section between the delivery pump and the pressure relief valve there is a heating means which is used to heat that part of the alcohol/water mixture which has been separated off. Furthermore, there are means for measuring the boiling temperature of the mixture. Pump, heating means and pressure relief valve are in this case preferably arranged in a bypass to the delivery line for the alcohol/water mixture.

That part of the alcohol/water mixture which has been separated off is transported to the pressure relief valve by means of the pump. The pump is used to build up a certain excess pressure, which is determined by the setting of the pressure relief valve. The excess pressure generated by the pump is advantageously—depending on requirements—between 0.2·10⁵ and 1·10⁵ Pa, and is preferably approximately 0.5·10⁵ Pa. This requires a substantially constantly operating pressure relief valve.

The delivery rate of the pump depends on the volume of the measurement cell and the response time of the sensor. For example, if the response time is 1 min and if the measurement cell has a volume of approx. 1 cm³, the delivery rate of the pump should be approx. 2 to 5 ml/min, i.e. 2 to 5 times the cell volume. Depending on the design of the measurement cell, this ensures virtually complete exchange of liquid.

If the pump delivery rate is, for example, 100 ml/h, the heat demand, calculated from the evaporation enthalpies for the evaporation of the liquid (water and alcohol), is approximately 30 W. Heat losses caused by insufficient insulation should be compensated for if appropriate.

A temperature-measuring unit (temperature sensor) with a defined electrical resistance, for example made from platinum, is preferably used to measure the boiling temperature of that part of the alcohol/water mixture which has been separated off. This ensures long-term stability of the measurement signal.

The measurement cell may advantageously be designed as a miniature cell or a microcell. In this case, the pressure relief valve is preferably a restrictor (capillary).

Other features which are considered as characteristic for the invention are set forth in the appended claims.

Although the invention is illustrated and described herein as embodied in a determination of the alcohol concentration in the electrolyte of fuel cells, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The figure is a highly schematic illustration of an exemplary fuel cell (DMFC) with a measurement apparatus according to the invention.

### DESCRIPTION OF A PREFERRED EMBODIMENT

Referring now to the sole figure of the drawing in detail, there is shown a direct methanol fuel cell DMFC with an anode 1, a cathode 2, and a membrane 3 for the hydrogen migration. An alcohol/water mixture CH₃OH+H₂O forms the fuel at the anode 1 and the reaction at the anode leads to the formation of carbon dioxide CO₂. The alcohol/water mixture is fed into the fuel cell from a reservoir 4 through a feed line 5. A bypass line 6 branches off from the main feed line 5 and the measurement apparatus according to the invention is connected inline in the bypass line 6.

A measurement cell 7 or measurement configuration is arranged in the bypass line for the alcohol/water mixture in between a pump 8 and a pressure relief valve 9. The configuration of the pump 8 and of the pressure relief valve 9 is in this case used to set the increase in pressure. As noted above, sufficient pressure increases are in the range from 0.2 to 1·10⁵ Pa, that is an excess pressure over ambient pressure.

A resistance heater 10 is indicated at the measurement cell 7. The heater 10 raises the temperature of the alcohol/water mixture for the purpose of measuring the boiling temperature of the mixture. From that measurement, it is possible to deduce the respective proportions of alcohol and of water in the mixture, i.e., the alcohol concentration in the mixture.

I claim:

1. A method of determining an alcohol concentration in an alcohol/water mixture of a fuel cell operated with the alcohol/water mixture, the method which comprises:
separating off a part of the alcohol/water mixture and transporting the part against a predetermined pressure;
heating the separated-off part of the alcohol/water mixture until boiling, and measuring a boiling temperature; and
determining, from the measured boiling temperature, a mole fraction of alcohol in the alcohol/water mixture.

2. The method according to claim 1, which comprises operating the fuel cell as a direct methanol fuel cell.

3. The method according to claim 1, which comprises setting the predetermined pressure to an excess pressure of between 0.2·10⁵ and 1·10⁵ Pa.

4. An apparatus for determining an alcohol concentration in an alcohol/water mixture of a fuel cell operated with the alcohol/water mixture and receiving the alcohol/water mixture through a delivery line, the apparatus comprising:
a branch line for branching off a part of the alcohol/water mixture;
a delivery pump arranged in said branch line;
a flow restriction in said branch line downstream of said delivery pump in a flow direction of the alcohol/water mixture;
a heating device disposed between said delivery pump and said flow restriction for heating the alcohol/water mixture, and a device for measuring a measuring a boiling temperature of the alcohol/water mixture.

5. The apparatus according to claim 4, wherein said flow restriction is a pressure relief valve connected inline in said branch line.

6. The apparatus according to claim 5, wherein said branch line is a bypass of a delivery line for the alcohol/water mixture to the fuel cell, and said pump, said heating device, and said pressure relief valve are arranged in said bypass.

7. The apparatus according to claim 4, wherein said flow restriction is a constriction.

8. The apparatus according to claim 4, wherein said heating device and said measuring device are a measuring unit with a defined electrical resistance for measuring the boiling temperature of the alcohol/water mixture.
